(19) United States
(12) Patent Application Publication
(10) Pub. No.: US 2012/0205545 A1
(43) Pub. Date: Aug. 16, 2012

(54) RADIOLOGICAL IMAGE DETECTION APPARATUS

(75) Inventors: Yasuhisa KANEKO, Kanagawa (JP); Haruyasu NAKATSUGAWA, Kanagawa (JP)

(73) Assignee: FUJIFILM CORPORATION, Tokyo (JP)

(21) Appl. No.: 13/361,731

(22) Filed: Jan. 30, 2012

(30) Foreign Application Priority Data
Feb. 15, 2011 (JP) 2011-030225

(51) Int. Cl. G01T 1/20

(52) U.S. Cl. 250/369

(57) ABSTRACT

A radiological image detection apparatus includes: a phosphor which contains a fluorescent material emitting fluorescence when exposed to radiation; and a sensor panel which detects the fluorescence; in which the sensor panel has a substrate and a group of photoelectric conversion elements provided on one side of the substrate; the phosphor adheres closely to an opposite surface of the substrate to the side where the group of photoelectric conversion elements are provided; and an irregular structure is formed in the surface of the substrate to which the phosphor adheres closely.

### CROSS-REFERENCE TO RELATED APPLICATIONS

This application is based on and claims priority under 35 USC 119 from Japanese Patent Application No. 2011-030225 filed on Feb. 15, 2011; the entire content of which is incorporated herein by reference.

### BACKGROUND

1. Technical Field

The present invention relates to a radiological image detection apparatus.

2. Related Art

In recent years, a radiological image detection apparatus using an FPD (Flat Panel Detector) for detecting a radiological image and generating digital image data has been put into practical use. The radiological image detection apparatus has been being widely used rapidly for the reason that an image can be confirmed in real time as compared with a background-art imaging plate. There are various systems for such a radiological image detection apparatus. An indirect conversion system has been known as one of the systems.

A radiological image detection apparatus using the indirect conversion system has a scintillator and a sensor panel. The scintillator is formed out of a fluorescent material such as CsI (sodium iodide) which generates fluorescence when exposed to radiation. The sensor panel has a group of photoelectric conversion elements formed on an insulating substrate of glass or the like. Radiation transmitted through a subject is once converted into light by the scintillator. The fluorescence of the scintillator is photoelectrically converted by the photoelectric conversion element group of the sensor panel, and digital image data is generated from an electric signal generated thus.

There has been also known a technique for forming a scintillator out of a group of columnar crystals in which crystals of a fluorescent material such as CsI have been grown into columnar shapes on a support by a vapor deposition method (for example, see Patent Document 1 (JP-A-2011-017683)). The columnar crystals formed by the vapor deposition method do not contain impurities such as a binder but have a light guide effect by which fluorescence generated in the columnar crystals can be guided in the growth direction of the crystals so as to suppress diffusion of the fluorescence. Thus, the sensitivity of the radiological image detection apparatus and the sharpness of an image can be improved.

The scintillator formed out of the group of columnar crystals of the fluorescent material is typically formed by using an aluminum deposition substrate as a support and growing up the group of columnar crystals on the support. By use of an adhesive agent, the scintillator is pasted to one side of the sensor panel where the group of photoelectric conversion elements have been formed. Alternatively, the scintillator may be formed in such a manner that the group of columnar crystals are formed by using the sensor panel as a support and growing the group of columnar crystals directly on the side of the sensor panel where the group of photoelectric conversion elements have been formed.

On the other hand, in order to improve the yield, there has been also known a radiological image detection apparatus in which a scintillator is provided on the substrate side of a sensor panel (see Patent Document 2 (JP-A-2005-114456)). Further, in order to improve the sensitivity, there has been also known a radiological image detection apparatus in which scintillators are provided on the opposite sides of a sensor panel, i.e. on one side of the sensor panel in which a group of photoelectric conversion elements have been formed and the substrate side of the sensor panel (see Patent Document 3 (JP-A-2007-163467)).

In a radiological image detection apparatus in which a scintillator is provided on the substrate side of a sensor panel, there is a fear that the scintillator may be separated from the sensor panel.

For example, when the scintillator is pasted to the substrate side of the sensor panel by use of an adhesive agent, there is a conspicuous difference in coefficient of linear expansion between glass used as an insulating substrate of the sensor panel and aluminum used as a support of the scintillator. As a result, warping caused by a temperature change generates stress in a bonding interface between the scintillator and the sensor panel. The stress can be indeed relaxed when a layer of the adhesive is thickened. However, since the substrate of the sensor panel is interposed between the scintillator and a photoelectric conversion element group of the sensor panel, thickening the adhesive layer brings about the further increase in the distance between the scintillator and the photoelectric conversion element group. Thus, there is a fear that fluorescence generated in the scintillator may be diffused to lower the sharpness of an image. On the contrary, when the adhesive layer is thinned, the stress generated in the bonding interface between the scintillator and the sensor panel cannot be relaxed sufficiently. Thus, there is a fear that the scintillator and the sensor panel may be separated from each other.

In addition, when columnar crystals are grown directly on the insulating substrate of the sensor panel to form the scintillator, the aforementioned problem of warping does not occur. However, CsI which forms the scintillator has poor adhesion to a low thermal-conductivity material such as glass used as the insulating substrate of the sensor panel. Also in this case, there is a fear that the scintillator may be separated from the sensor panel.

### SUMMARY

An illustrative aspect of the invention is to improve the adhesion between a sensor panel and a phosphor in a radiological image detection apparatus in which the phosphor is located on the substrate side of the sensor panel.

According to an aspect of the invention, a radiological image detection apparatus includes: a phosphor which contains a fluorescent material emitting fluorescence when exposed to radiation; and a sensor panel which detects the fluorescence; in which the sensor panel has a substrate and a group of photoelectric conversion elements provided on one side of the substrate; the phosphor adheres closely to an opposite surface of the substrate to the side where the group of photoelectric conversion elements are provided; and an irregular structure is formed in the surface of the substrate to which the phosphor adheres closely.

According to the radiological image detection apparatus, it is possible to enhance the adhesion between a sensor panel and a phosphor in a radiological image detection apparatus in which the phosphor is located on the substrate side of the sensor panel.

### BRIEF DESCRIPTION OF THE DRAWINGS

FIG. 1 is a view schematically showing a configuration of an example of a radiological image detection apparatus for explaining a mode for carrying out the invention.

FIG. 2 is a view schematically showing a configuration of a sensor panel of the radiological image detection apparatus in FIG. 1.

FIG. 3 is a view schematically showing a configuration of a phosphor of the radiological image detection apparatus in FIG. 1.

FIG. 4 is a sectional view of the phosphor taken on line IV-IV in FIG. 3.

FIG. 5 is a sectional view of the phosphor taken on line V-V in FIG. 3.

FIG. 6 is a view schematically showing a bonding interface between the phosphor and the sensor panel in the radiological image detection apparatus in FIG. 1.

FIG. 7 is a view schematically showing a configuration of another example of a radiological image detection apparatus for explaining the mode for carrying out the invention.

FIG. 8 is a view schematically showing a bonding interface between a phosphor and a sensor panel in the radiological image detection apparatus in FIG. 7.

### DETAILED DESCRIPTION

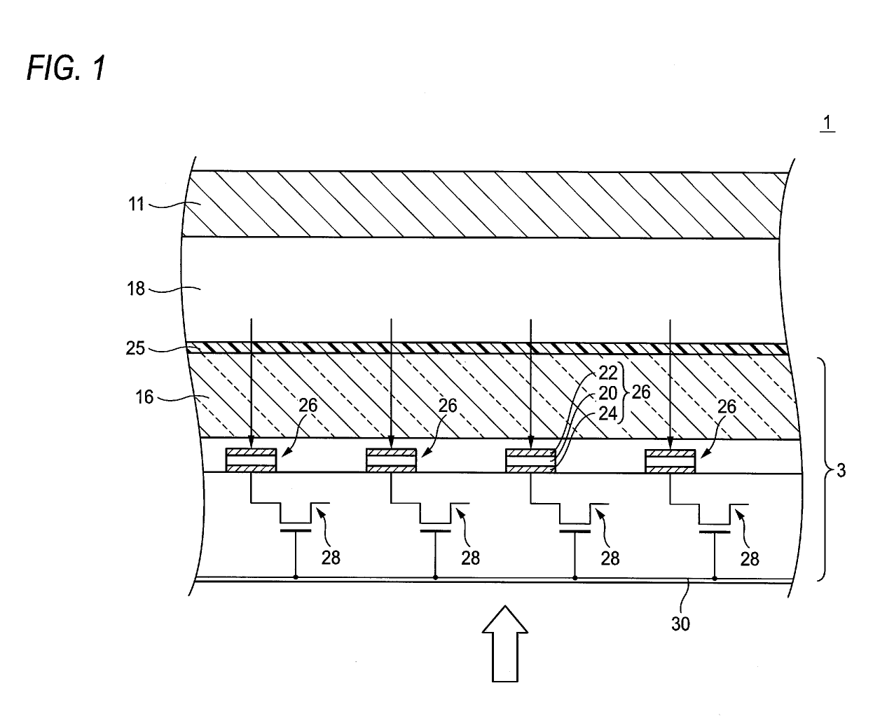

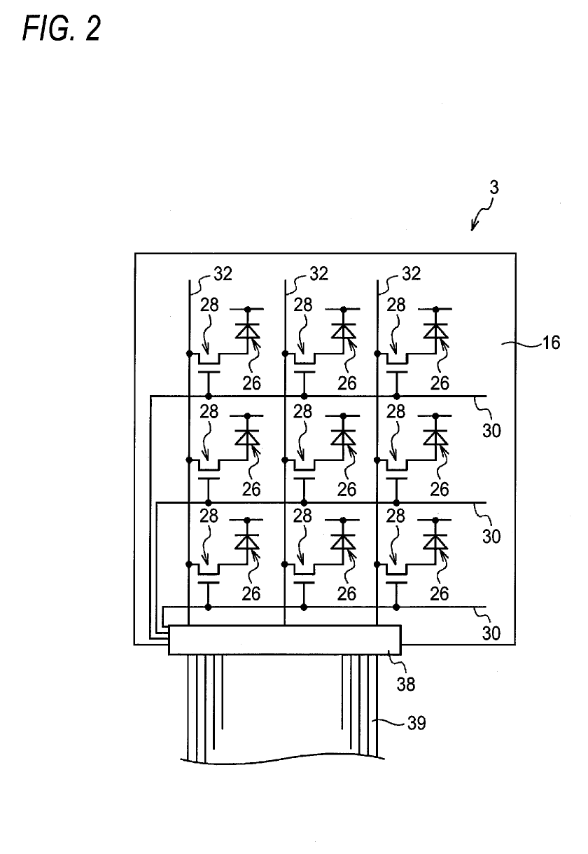

FIG. 1 shows a configuration of an example of a radiological image detection apparatus for explaining a mode for carrying out the invention. FIG. 2 shows a configuration of a sensor panel of the radiological image detection apparatus in FIG. 1.

A radiological image detection apparatus 1 has a scintillator (phosphor) 18 which emits fluorescence when exposed to radiation, and a sensor panel 3 which detects the fluorescence of the scintillator 18.

The sensor panel 3 has an insulating substrate 16 which can transmit the fluorescence of the scintillator 18. A plurality of photoelectric conversion elements 26 photoelectrically converting the fluorescence of the scintillator 18, and switching devices 28 consisting of TFTs (Thin Film Transistors) are provided on the insulating substrate 16 so as to be arrayed two-dimensionally.

Each photoelectric conversion element 26 consists of a photoconductive layer 20 which generates electric charges when light is incident thereon, and a pair of electrodes which are provided on the front and back surfaces of the photoconductive layer 20. Of them, one electrode 22 is a bias electrode for applying a bias voltage to the photoconductive layer 20, and the other electrode 24 is a charge collection electrode for collecting the electric charges generated by the photoconductive layer 20.

The switching devices 28 are arrayed two-dimensionally correspondingly to the two-dimensional array of the photoelectric conversion elements 26. The charge collection electrode 24 of each photoelectric conversion element 26 is connected to a corresponding one of the switching devices 28. Electric charges collected by each charge collection electrode 24 are read out through the corresponding switching device 28.

A plurality of gate lines 30 and a plurality of signal lines (data lines) 32 are provided in the insulating substrate 16. The gate lines 30 are provided to extend in one direction (row direction) so as to turn on/off the switching devices 28 respectively. The signal lines 32 are provided to extend in a perpendicular direction (column direction) to the gate lines 30 so as to read out electric charges through the switching devices 28 which have been turned on. In addition, a connection terminal 38 to which the gate lines 30 and the signal lines 32 are connected individually is disposed in a circumferential edge portion of the insulating substrate 16. The connection terminal 38 is connected to a circuit board (not shown) through a connection circuit 39 as shown in FIG. 2. The circuit board includes a gate line driver an external circuit, and a signal processing portion.

The switching devices 28 are turned on sequentially row by row in accordance with signals supplied through the gate lines 30 from the gate line driver respectively. Electric charges read out by the switching devices 28 which have been turned on are transmitted as charge signals through the signal lines 32 and supplied to the signal processing portion. Thus, the electric charges are read out sequentially row by row, and converted into an electric signal in the signal processing portion so that digital image data is generated.

The scintillator 18 is formed on a support 11. An opposite surface of the scintillator 18 to the support 11 is pasted onto the insulating substrate 16 of the sensor panel 3 through an adhesive layer 25 which is located between the scintillator 18 and the insulating substrate 16.

The radiological image detection apparatus 1 in the example is a so-called ISS (Irradiation Side Sampling) radiological image detection apparatus, in which radiation radiated from the sensor panel 3 side and transmitted through the sensor panel 3 is incident on the scintillator 18. Fluorescence is generated in the scintillator 18 on which the radiation is incident. The fluorescence generated thus in the scintillator 18 is photoelectrically converted by the photoelectric conversion elements 26 of the sensor panel 3. In the radiological image detection apparatus 1 configured thus, the radiation entrance side of the scintillator 18 where plenty of fluorescence is generated is disposed adjacently to the sensor panel 3 so that the sensitivity is improved.

Further, in the illustrated example, the group of photoelectric conversion elements 26 and the group of switching devices 28 are formed in different layers, and the photoelectric conversion element layer and the switching device layer are formed in ascending order of the distance from the insulating substrate 16. Incidentally, the group of photoelectric conversion elements 26 and the group of switching devices 28 may be formed in one and the same layer, or the switching device layer and the photoelectric conversion element layer may be formed in ascending order of the distance from the insulating substrate 16. However, when the group of photoelectric conversion elements 26 and the group of switching devices 28 are formed in different layers as in the illustrated example, the dimensions of each photoelectric conversion element 26 can be increased. In addition, when the photoelectric conversion element layer and the switching device layer are formed in ascending order of the distance from the insulating substrate 16, the photoelectric conversion element layer can be disposed more closely to the scintillator 18. In this manner, the sensitivity can be improved.

The scintillator 18 will be described in detail below.

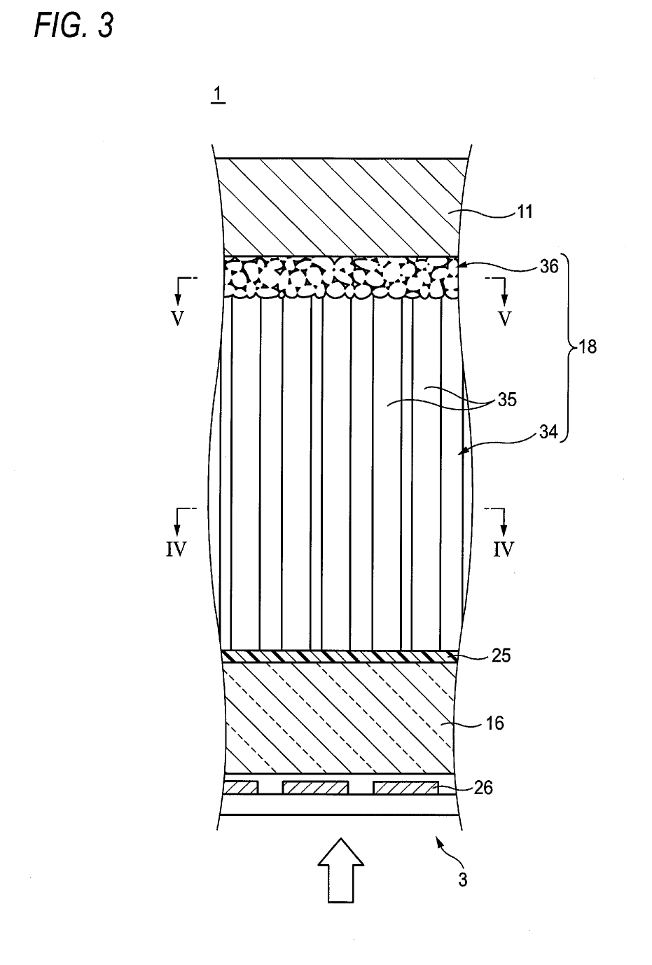

FIG. 3 schematically shows the configuration of the scintillator 18.

An aluminum plate is typically used as the support 11 on which the scintillator 18 is formed. The support 11 is not limited to the aforementioned plate as long as the scintillator 18 can be formed thereon. In addition to the aluminum plate, for example, a carbon plate, a CFRP (Carbon Fiber Reinforced Plastic) plate, a glass plate, a quartz substrate, a sapphire substrate, a metal plate of iron, tin, chromium or the like, etc. may be used as the support 11.

For example, CsI:Tl (thallium doped cesium iodide), NaLTl (thallium doped sodium iodide), CsI:Na (sodium doped cesium iodide), etc. may be used as fluorescent materials for forming the scintillator 18. Of them, CsI:Tl is preferred because the emission spectrum thereof conforms to the maximum value (around 550 nm) of spectral sensitivity of an a-Si photodiode.

The scintillator 18 is constituted by a columnar portion 34 provided on the opposite side to the support 11 and a non-columnar portion 36 provided on the support 11 side. The columnar portion 34 and the non-columnar portion 36 which will be described in details later are formed to be laid on each other like layers continuously on the support 11 by a vapor deposition method. The columnar portion 34 and the non-columnar portion 36 are formed out of one and the same fluorescent material, but the doping amount of an activator such as Tl may differ between the columnar portion 34 and the non-columnar portion 36.

The columnar portion 34 is formed out of a group of columnar crystals 35 which are obtained by growing crystals of the aforementioned fluorescent material into columnar shapes. There may be a case where a plurality of adjacent columnar crystals are coupled to form one columnar crystal. An air gap is put between adjacent columnar crystals 35 so that the columnar crystals 35 exist independently of one another.

The non-columnar portion 36 is formed out of a group of comparatively small crystals of the fluorescent material. There may be a case where the non-columnar portion 36 includes an amorphous material of the aforementioned fluorescent material. In the non-columnar portion 36, the crystals are irregularly coupled or laid on one another so that no distinct air gap can be produced among the crystals.

Of the scintillator 18, the opposite surface to the support 11, that is, the surface on a front end side of each columnar crystal of the columnar portion 34 is pasted to the sensor panel 3. Accordingly, the columnar portion 34 consisting of the group of the columnar crystals 35 is disposed on the radiation entrance side of the scintillator 18.

Fluorescence generated in each columnar crystal 35 of the columnar portion 34 is totally reflected in the columnar crystal 35 repeatedly due to a difference in refractive index between the columnar crystal 35 and a gap (air) surrounding the columnar crystal 35, so as to be restrained from being diffused. Thus, the fluorescence is guided to the photoelectric conversion element 26 opposed to the columnar crystal 35. Thus, the sharpness of the image is improved.

Of the fluorescence generated in each columnar crystal 35 of the columnar portion 34, fluorescence travelling toward the opposite side to the sensor panel 3, that is, toward the support 11, is reflected toward the sensor panel 3 by the non-columnar portion 36. Thus, the utilization efficiency of the fluorescence is enhanced so that the sensitivity is improved.

In addition, each columnar crystal 35 of the columnar portion 34 is comparatively thin in an early stage of its growth and thickened with the progression of the growth of the crystal. In the bonding portion of the columnar portion 34 to the non-columnar portion 36, the small-diameter columnar crystals 35 stand together with a large void ratio due to a large number of comparatively large air gaps extending in the growth direction of the crystals. On the other hand, the non-columnar portion 36 is formed out of comparatively small crystals or an aggregate thereof. The non-columnar portion 36 is denser than the columnar portion 34 and has a smaller void ratio due to individual air gaps which are comparatively small. Due to the non-columnar portion 36 interposed between the support 11 and the columnar portion 34, the adhesion between the support 11 and the scintillator 18 is improved to prevent the scintillator 18 from being separated from the support 11.

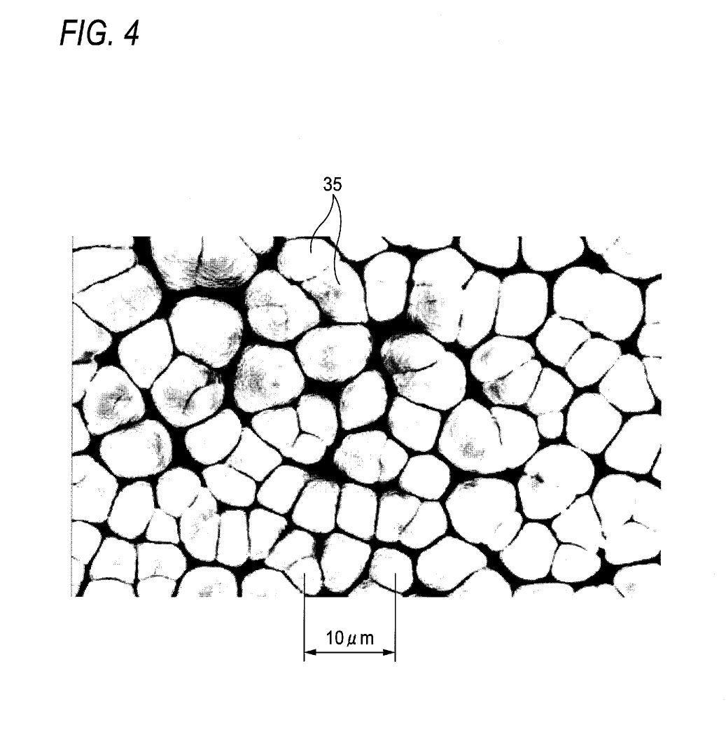

FIG. 4 shows an electron microscope photograph showing a section of the scintillator 18 taken on line IV-IV in FIG. 3.

As is apparent from FIG. 4, it is understood that, in the columnar portion 34, each columnar crystal 35 shows a substantially uniform sectional diameter with respect to the growth direction of the crystal, and the columnar crystals 35 exist independently of one another due to an air gap around each columnar crystal 35. It is preferable that the crystal diameter (columnar diameter) of each columnar crystal 35 is not smaller than 2 μm and not larger than 8 μm, from the viewpoints of light guide effect, mechanical strength and pixel defect prevention. When the columnar diameter is too small, each columnar crystal 35 is short of mechanical strength so that there is a fear that the columnar crystal 35 may be damaged by a shock or the like. When the crystal diameter is too large, the number of columnar crystals 35 for each photoelectric conversion element 26 is reduced so that there is a fear that it is highly likely that the element may be defective when one of the crystals corresponding thereto is cracked. The number of columnar crystals for each photoelectric conversion element 26 depends on the size of the photoelectric conversion element 26, but is typically in a range of from several tens to several hundreds.

Here, the crystal diameter designates the maximum diameter of a columnar crystal 35 observed from above in the growth direction of the crystal. As for a specific measurement method, the columnar diameter of each columnar crystal 35 is measured by observation in an SEM (Scanning Electron Microscope) from the growth-direction top of the columnar crystal 35. The observation is performed in the magnification (about 2,000 times) with which 100 to 200 columnar crystals 35 can be observed in each shot. The maximum values of columnar diameters of all the crystals taken in the shot are measured and averaged. An average value obtained thus is used. The columnar diameters (μm) are measured to two places of decimals, and the average value is rounded in the two places of decimals according to JIS Z 8401.

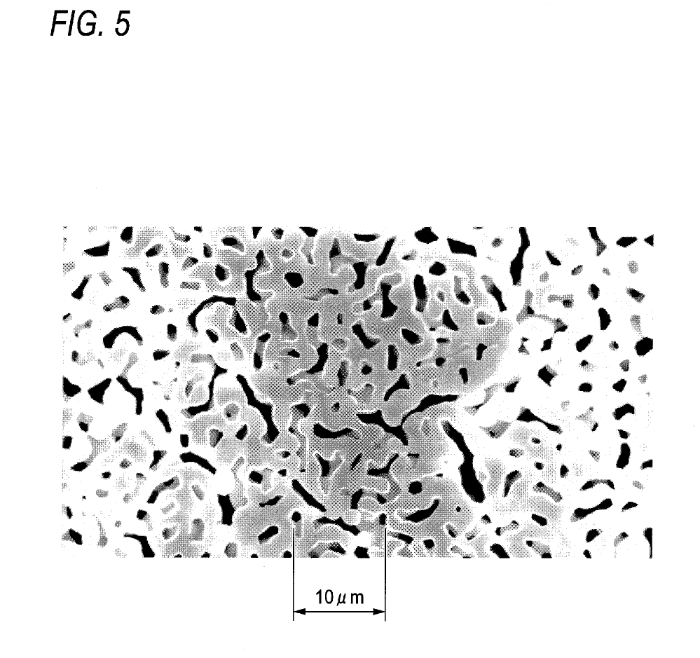

FIG. 5 shows an electron microscope photograph showing a section of the scintillator 18 taken on line V-V in FIG. 3.

As is apparent from FIG. 5, in the non-columnar portion 36, crystals are irregularly coupled or laid on one another so that no distinct air gap among the crystals can be recognized in comparison with the columnar portion 34. From the viewpoints of adhesion and optical reflection, it is preferable that the diameter of each crystal forming the non-columnar portion 36 is not smaller than 0.5 μm and not larger than 7.0 μm. When the crystal diameter is too small, the void ratio is close to zero so that there is a fear that the function of optical reflection may deteriorate. When the crystal diameter is too large, the flatness deteriorates so that there is a fear that the adhesion to the support 11 may deteriorate. In addition, from the viewpoint of optical reflection, it is preferable that the shape of each crystal forming the non-columnar portion 36 is substantially spherical.

When crystals are coupled with each other in the non-columnar portion 36, the crystal diameter of each crystal is measured as follows. That is, a line obtained by connecting recesses (concaves) generated between adjacent crystals is regarded as the boundary between the crystals. The crystals coupled with each other are separated to have minimum polygons. The columnar diameters and the crystal diameters corresponding to the columnar diameters are measured thus. An average value of the crystal diameters is obtained in the same manner as the crystal diameter in the columnar portion 34. The average value obtained thus is used as the crystal diameter in the non-columnar portion 36.

In addition, the thickness of the columnar portion 34 depends on the energy of radiation but is preferably not smaller than 200 μm and not larger than 700 μm in order to secure sufficient radiation absorption in the columnar portion 34 and sufficient image sharpness. When the thickness of the columnar portion 34 is too small, radiation cannot be absorbed sufficiently so that there is a fear that the sensitivity may deteriorate. When the thickness of the columnar portion 34 is too large, optical diffusion occurs so that there is a fear that the image sharpness may deteriorate in spite of the light guide effect of the columnar crystals.

It is preferable that the thickness of the non-columnar portion 36 is not smaller than 5 μm and not larger than 125 μm from the viewpoint of adhesion to the support 11 and optical reflection. When the thickness of the non-columnar portion 36 is too small, there is a fear that sufficient adhesion to the support 11 cannot be obtained. When the thickness of the non-columnar portion 36 is too large, contribution of fluorescence in the non-columnar portion 36 and diffusion caused by optical reflection in the non-columnar portion 36 increase so that there is a fear that the image sharpness may deteriorate.

The non-columnar portion 36 and the columnar portion 34 of the scintillator 18 are formed on the support 11, for example, by a vapor deposition method integrally and continuously in that order. Specifically, under the environment with a vacuum degree of 0.01 to 10 Pa, CsI:Tl is heated and evaporated by means of resistance heating crucibles to which electric power is applied. Thus, CsI:Tl is deposited on the support 11 whose temperature is set at a room temperature (20° C.) to 300° C.

At the beginning of formation of a crystal phase of CsI:Tl on the support 11, comparatively small-diameter crystals are deposited to form the non-columnar portion 36. At least one of the conditions, that is, the degree of vacuum or the temperature of the support 11 is then changed. Thus, the columnar portion 34 is formed continuously after the non-columnar portion 36 is formed. Specifically, the degree of vacuum and/or the temperature of the support 11 are increased so that a group of columnar crystals 35 are grown.

In the aforementioned manner, the scintillator 18 can be manufactured efficiently and easily. In addition, according to the manufacturing method, there is another advantage that scintillators of various specifications can be manufactured easily in accordance with their designs when the degree of vacuum or the temperature of the support is controlled in formation of the scintillator 18.

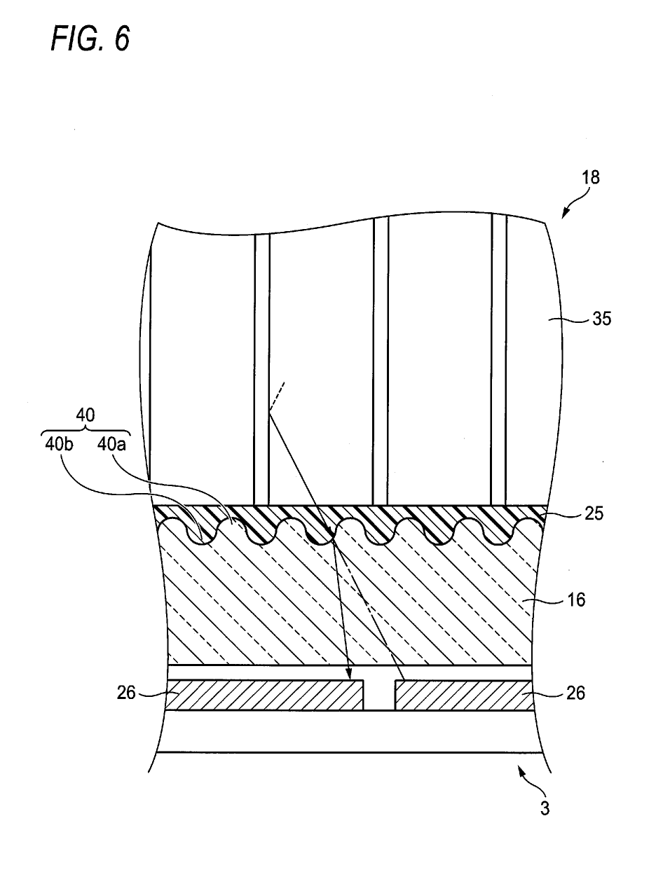

FIG. 6 shows an enlarged bonding interface between the scintillator 18 and the sensor panel 3.

A fine irregular structure 40 is provided all over a surface of the insulating substrate 16 of the sensor panel 3, to which the scintillator 18 is pasted through the adhesive layer 25.

It is preferable that the array pitch of concave portions 40b or convex portions 40a in the irregular structure 40 is sufficiently smaller than the size of each photoelectric conversion element 26. In this manner, the number of concave portions 40b or convex portions 40a for each photoelectric conversion element 26 can be substantially equalized to prevent image unevenness.

With provision of the irregular structure 40, an adhesive agent, a pressure sensitive adhesive agent, or the like, which forms the adhesive layer 25 enters the concave portions of the irregular structure 40 to expand the contact area between the insulating substrate 16 and the adhesive layer 25. Thus, the adhesion of the scintillator 18 to the insulating substrate 16 through the adhesive layer 25 can be enhanced to prevent the scintillator 18 from being separated from the insulating substrate 16 even if the adhesive layer 25 is thinned.

Further, in the irregular structure 40, each convex portion 40a is formed substantially into a cone shape so as to form a substantially reflection-free surface structure. Reflection of light is caused by a sudden change of refractive index. However, the fine irregular structure 40 has a refractive index distribution in which the average refractive index in a plane perpendicular to a superposition direction of the scintillator 18 on the insulating substrate 16 varies smoothly in the superposition direction. Thus, the fluorescence emitted from the scintillator 18 is restrained from being reflected by the surface of the insulating substrate 16, so that the sensitivity can be improved. Further, the reflection-free structure using the fine irregular structure 40 is different from background-art antireflection coating and also effective for light with a wide wavelength band and a wide range of incident angles.

It is preferable that the material forming the adhesive layer 25 for filling the concave portions 40b of the irregular structure 40 has a substantially equal refractive index to that of the material forming the scintillator 18. In this manner, the refractive index can be prevented from being discontinuous between the scintillator 18 and the insulating substrate 16, so that reflection in the bonding interface between the scintillator 18 and the sensor panel 3 can be suppressed more greatly. Thus, the sensitivity can be improved.

The array pitch of the concave portions 40b or the convex portions 40a in the irregular structure 40 is preferably not longer than the wavelength (around 550 nm when the scintillator 18 is formed out of CsI) of light to be restrained from being reflected.

The shape of each concave portion 40b in the irregular structure 40 is not limited particularly, but is preferably a substantially lens-surface shape. In this manner, a light condensing effect in the concave portions 40b can be found, so that the fluorescence emitted from each columnar crystal 35 of the scintillator 18 can be restrained from being diffused circumferentially. Thus, the image sharpness can be improved.

The aforementioned irregular structure 40 can be formed, for example, by lithographic patterning on the insulating substrate 16 or shape transfer to the insulating substrate 16 using a mold. The aforementioned irregular structure 40 may be formed after the insulating substrate 16 has been polished and thinned. In this manner, the distance between the scintillator 18 and the group of photoelectric conversion elements 26 can be shortened to suppress diffusion of fluorescence emitted from each columnar crystal 35 of the scintillator 18. Thus, the image sharpness can be improved.

Although the aforementioned radiological image detection apparatus 1 has been described on the assumption that radiation is incident thereon from the sensor panel 3 side, the radiological image detection apparatus 1 may use a configuration in which radiation is incident thereon from the scintillator 18 side.

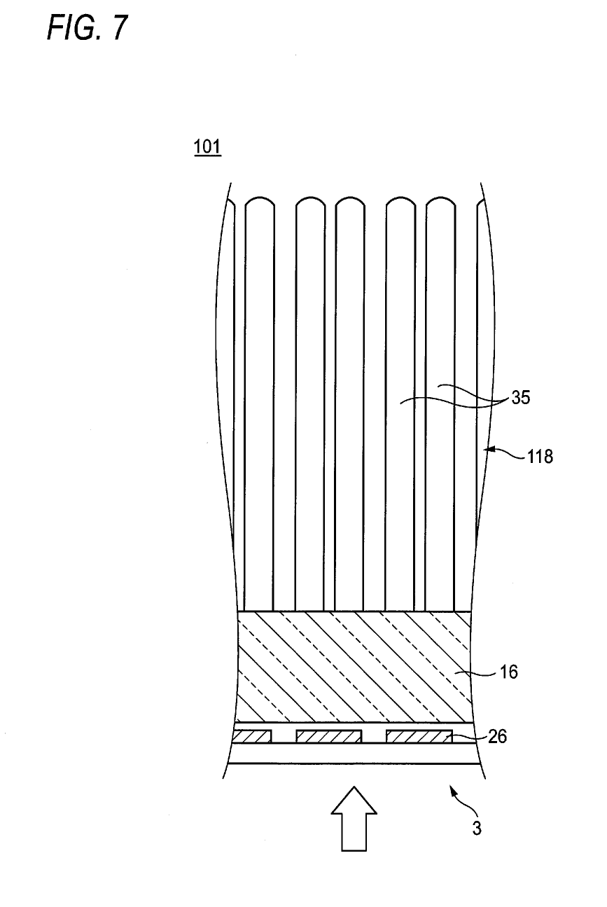

FIG. 7 schematically shows a configuration of another example of a radiological image detection apparatus for explaining the mode for carrying out the invention.

A radiological image detection apparatus 101 shown in FIG. 7 has a scintillator (phosphor) 118 which emits fluorescence when exposed to radiation, and a sensor panel 3 which detects the fluorescence of the scintillator 118. The scintillator 118 is formed out of a group of columnar crystals 35 which are obtained by growing crystals of a fluorescent material into columnar shapes.

The scintillator 18 is formed on the support 11 and pasted to the sensor panel 3 through the adhesive layer 25 in the aforementioned radiological image detection apparatus 1. On the other hand, the scintillator 118 in this example uses the insulating substrate 16 of the sensor panel 3 as a support. That is, the group of columnar crystals 35 in the scintillator 118 in this example are grown and formed by a vapor deposition method directly on the opposite surface of the insulating substrate 16 to the surface where a group of photoelectric conversion elements 26 are formed. Since the crystals of the fluorescent material are deposited on the opposite side of the insulating substrate 16 to the side where the group of photoelectric conversion elements 26 are formed, thermal degradation of the photoelectric conversion elements 26 or the switching devices 28 can be suppressed.

Alternatively, the group of photoelectric conversion elements 26 and the group of switching devices 28 are formed into layers on another temporary substrate than the insulating substrate 16. After whether the scintillator 118 formed on the insulating substrate 16 is good or bad is confirmed, the layers of the photoelectric conversion elements 26 and the switching devices 28 formed on the temporary substrate are pasted onto the opposite surface of the insulating substrate 16 to the side where the scintillator is formed. The temporary substrate is then separated. In this manner, the thermal degradation of the photoelectric conversion elements 26 and the switching devices 28 can be further suppressed, while the yield can be improved.

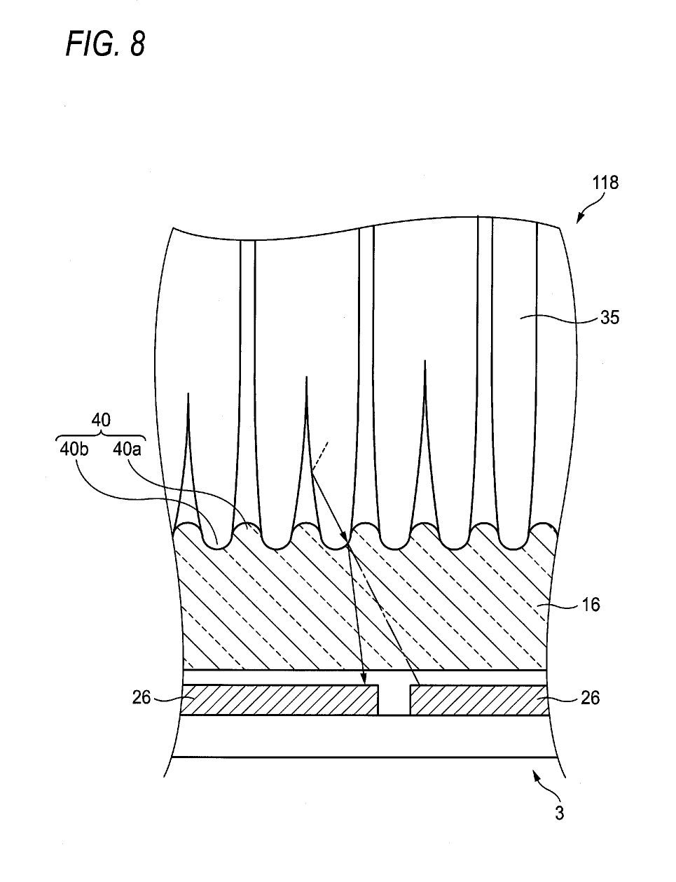

FIG. 8 shows an enlarged bonding interface between the scintillator 118 and the sensor panel 3.

The aforementioned fine irregular structure 40 forming a reflection-free surface structure is provided all over the surface of the insulating substrate 16 of the sensor panel 3, where the scintillator 118 is formed.

Each columnar crystal 35 forming the scintillator 118 grows on each concave portion 40b of the irregular structure 40 as a starting point so as to expand a contact area between a base end portion of the columnar crystal 35 and the insulating substrate 16. Thus, the adhesion between the scintillator 118 and the insulating substrate 16 is enhanced so that the scintillator 118 can be prevented from being separated from the insulating substrate 16. In addition, the uniformity of the distribution of the columnar crystals 35 is enhanced.

In the scintillator 118, the non-columnar portion 36 in the aforementioned scintillator 18 may be provided on a front end side of the group of columnar crystals 35. With provision of the non-columnar portion 36, part of fluorescence which is generated in each columnar crystal 35 but travels toward the opposite side to sensor panel 3 can be reflected toward the sensor panel 3 by the non-columnar portion 36. Thus, the utilization efficiency of the fluorescence can be enhanced to improve the sensitivity.

Since the aforementioned radiological image detection apparatus can detect a radiological image with high sensitivity and high definition, it can be installed and used in an X-ray imaging apparatus for the purpose of medical diagnosis, such as a mammography apparatus, required to detect a sharp image with a low dose of radiation, and other various apparatuses. For example, the radiological image detection apparatus is applicable to an industrial X-ray imaging apparatus for nondestructive inspection, or an apparatus for detecting particle rays (α-rays, β-rays, γ-rays) other than electromagnetic waves. The radiological image detection apparatus has a wide range of applications.

Description will be made below on materials which can be used for constituent members of the sensor panel 3.

[Photoelectric Conversion Element]

Inorganic semiconductor materials such as amorphous silicon are often used for the photoconductive layer 20 (see FIG. 1) of the aforementioned photoelectric conversion elements 26. For example, any OPC (Organic Photoelectric Conversion) material disclosed in JP-A-2009-32854 may be used. A film formed out of the OPC material (hereinafter referred to as OPC film) may be used as the photoconductive layer 20. The OPC film contains an organic photoelectric conversion material, absorbing light emitted from a phosphor layer and generating electric charges in accordance with the absorbed light. Such an OPC film containing an organic photoelectric conversion material has a sharp absorption spectrum in a visible light range. Thus, electromagnetic waves other than light emitted from the phosphor layer are hardly absorbed by the OPC film, but noise generated by radiation such as X-rays absorbed by the OPC film can be suppressed effectively.

It is preferable that the absorption peak wavelength of the organic photoelectric conversion material forming the OPC film is closer to the peak wavelength of light emitted by the phosphor layer in order to more efficiently absorb the light emitted by the phosphor layer. Ideally, the absorption peak wavelength of the organic photoelectric conversion material agrees with the peak wavelength of the light emitted by the phosphor layer. However, if the difference between the absorption peak wavelength of the organic photoelectric conversion material and the peak wavelength of the light emitted by the phosphor layer is small, the light emitted by the phosphor layer can be absorbed satisfactorily. Specifically, the difference between the absorption peak wavelength of the organic photoelectric conversion material and the peak wavelength of the light emitted by the phosphor layer in response to radioactive rays is preferably not larger than 10 nm, more preferably not larger than 5 nm.

Examples of the organic photoelectric conversion material that can satisfy such conditions include arylidene-based organic compounds, quinacridone-based organic compounds, and phthalocyanine-based organic compounds. For example, the absorption peak wavelength of quinacridone in a visible light range is 560 nm. Therefore, when quinacridone is used as the organic photoelectric conversion material and CsI(Tl) is used as the phosphor layer material, the aforementioned difference in peak wavelength can be set within 5 nm so that the amount of electric charges generated in the OPC film can be increased substantially to the maximum.

At least a part of an organic layer provided between the bias electrode 22 and the charge collection electrode 24 can be formed out of an OPC film. More specifically, the organic layer can be formed out of a stack or a mixture of a portion for absorbing electromagnetic waves, a photoelectric conversion portion, an electron transport portion, an electron hole transport portion, an electron blocking portion, an electron hole blocking portion, a crystallization prevention portion, electrodes, interlayer contact improvement portions, etc.

Preferably the organic layer contains an organic p-type compound or an organic n-type compound. An organic p-type semiconductor (compound) is a donor-type organic semiconductor (compound) as chiefly represented by an electron hole transport organic compound, meaning an organic compound having characteristic to easily donate electrons. More in detail, of two organic materials used in contact with each other, one with lower ionization potential is called the donor-type organic compound. Therefore, any organic compound may be used as the donor-type organic compound as long as the organic compound having characteristic to donate electrons. Examples of the donor-type organic compound that can be used include a triarylamine compound, a benzidine compound, a pyrazoline compound, a styrylamine compound, a hydrazone compound, a triphenylmethane compound, a carbazole compound, a polysilane compound, a thiophene compound, a phthalocyanine compound, a cyanine compound, a merocyanine compound, an oxonol compound, a polyamine compound, an indole compound, a pyrrole compound, a pyrazole compound, a polyarylene compound, a fused aromatic carbocyclic compound (naphthalene derivative, anthracene derivative, phenanthrene derivative, tetracene derivative, pyrene derivative, perylene derivative, fluoranthene derivative), a metal complex having a nitrogen-containing heterocyclic compound as a ligand, etc. The donor-type organic semiconductor is not limited thereto but any organic compound having lower ionization potential than the organic compound used as an n-type (acceptor-type) compound may be used as the donor-type organic semiconductor.

The n-type organic semiconductor (compound) is an acceptor-type organic semiconductor (compound) as chiefly represented by an electron transport organic compound, meaning an organic compound having characteristic to easily accept electrons. More specifically, when two organic compounds are used in contact with each other, one of the two organic compounds with higher electron affinity is the acceptor-type organic compound. Therefore, any organic compound may be used as the acceptor-type organic compound as long as the organic compound having characteristic to accept electrons. Examples thereof include a fused aromatic carbocyclic compound (naphthalene derivative, anthracene derivative, phenanthrene derivative, tetracene derivative, pyrene derivative, perylene derivative, fluoranthene derivative), a 5- to 7-membered heterocyclic compound containing a nitrogen atom, an oxygen atom or a sulfur atom (e.g. pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyralidine, pyrrolopyridine, thiadiazolopyridine, dibenzazepine, tribenzazepine etc.), a polyarylene compound, a fluorene compound, a cyclopentadiene compound, a silyl compound, and a metal complex having a nitrogen-containing heterocyclic compound as a ligand. The acceptor-type organic semiconductor is not limited thereto. Any organic compound may be used as the acceptor-type organic semiconductor as long as the organic compound has higher electron affinity than the organic compound used as the donor-type organic compound.

As for p-type organic dye or n-type organic dye, any known dye may be used. Preferred examples thereof include cyanine dyes, styryl dyes, hemicyanine dyes, merocyanine dyes (including zero-methine merocyanine (simple merocyanine)), trinuclear merocyanine dyes, tetranuclear merocyanine dyes, rhodacyanine dyes, complex cyanine dyes, complex merocyanine dyes, alopolar dyes, oxonol dyes, hemioxonol dyes, squarylium dyes, croconium dyes, azamethine dyes, coumarin dyes, arylidene dyes, anthraquinone dyes, triphenylmethane dyes, azo dyes, azomethine dyes, spiro compounds, metallocene dyes, fluorenone dyes, flugide dyes, perylene dyes, phenazine dyes, phenothiazine dyes, quinone dyes, indigo dyes, diphenylmethane dyes, polyene dyes, acridine dyes, acridinone dyes, diphenylamine dyes, quinacridone dyes, quinophthalone dyes, phenoxazine dyes, phthaloperylene dyes, porphyrin dyes, chlorophyll dyes, phthalocyanine dyes, metal complex dyes, and fused aromatic carbocyclic dyes (naphthalene derivative, anthracene derivative, phenanthrene derivative, tetracene derivative, pyrene derivative, perylene derivative, fluoranthene derivative).

A photoelectric conversion film (photosensitive layer) which has a layer of a p-type semiconductor and a layer of an n-type semiconductor between a pair of electrodes and at least one of the p-type semiconductor and the n-type semiconductor is an organic semiconductor and in which a bulk heterojunction structure layer including the p-type semiconductor and the n-type semiconductor is provided as an intermediate layer between those semiconductor layers may be used preferably. The bulk heterojunction structure layer included in the photoelectric conversion film can cover the defect that the carrier diffusion length of the organic layer is short. Thus, the photoelectric conversion efficiency can be improved. The bulk heterojunction structure has been described in detail in JP-A-2005-303266.

It is preferable that the photoelectric conversion film is thicker in view of absorption of light from the phosphor layer. The photoelectric conversion film is preferably not thinner than 30 nm and not thicker than 300 nm, more preferably not thinner than 50 nm and not thicker than 250 nm, particularly more preferably not thinner than 80 nm and not thicker than 200 nm in consideration of the ratio which does make any contribution to separation of electric charges.

As for any other configuration about the aforementioned OPC film, for example, refer to description in JP-A-2009-32854.

[Switching Device]

Inorganic semiconductor materials such as amorphous silicon are often used for an active layer of each switching device 28. However, any organic material, for example, as disclosed in JP-A-2009-212389, may be used. Although the organic TFT may have any type of structure, a field effect transistor (FET) structure is the most preferable. In the FET structure, a gate electrode is provided on a part of an upper surface of an insulating substrate, and an insulator layer is provided to cover the electrode and touch the substrate in the other portion than the electrode. Further, a semiconductor active layer is provided on an upper surface of the insulator layer, and a transparent source electrode and a transparent drain electrode are disposed on a part of an upper surface of the semiconductor active layer and at a distance from each other. This configuration is called a top contact type device. However, a bottom contact type device in which a source electrode and a drain electrode are disposed under a semiconductor active layer may be also used preferably. In addition, a vertical transistor structure in which a carrier flows in the thickness direction of an organic semiconductor film may be used.

(Active Layer)

Organic semiconductor materials mentioned herein are organic materials showing properties as semiconductors. Examples of the organic semiconductor materials include p-type organic semiconductor materials (or referred to as p-type materials simply or as electron hole transport materials) which conduct electron holes (holes) as carriers, and n-type organic semiconductor materials (or referred to as n-type materials simply or as electrode transport materials) which conduct electrons as carriers, similarly to a semiconductor formed out of an inorganic material. Of the organic semiconductor materials, lots of p-type materials generally show good properties. In addition, p-type transistors are generally excellent in operating stability as transistors under the atmosphere. Here, description here will be made on a p-type organic semiconductor material.

One of properties of organic thin film transistors is a carrier mobility (also referred to as mobility simply)μ which indicates the mobility of a carrier in an organic semiconductor layer. Although preferred mobility varies in accordance with applications, higher mobility is generally preferred. The mobility is preferably not lower than 1.0*10⁻⁷ cm²/Vs, more preferably not lower than 1.0*10⁻⁶ cm²/Vs, further preferably not lower than 1.0*10⁻⁵ cm²/Vs. The mobility can be obtained by properties or TOF (Time Of Flight) measurement when the field effect transistor (FET) device is manufactured.

The p-type organic semiconductor material may be either a low molecular weight material or a high molecular weight material, but preferably a low molecular weight material. Lots of low molecular weight materials typically show excellent properties due to easiness in high purification because various refining processes such as sublimation refining, recrystallization, column chromatography, etc. can be applied thereto, or due to easiness in formation of a highly ordered crystal structure because the low molecular weight materials have a fixed molecular structure. The molecular weight of the low molecular weight material is preferably not lower than 100 and not higher than 5,000, more preferably not lower than 150 and not higher than 3,000, further more preferably not lower than 200 and not higher than 2,000.

A phthalocyanine compound or a naphthalocyanine compound may be exemplified as such a p-type organic semiconductor material. A specific example thereof is shown as follows. M represents a metal atom, Bu represents a butyl group, Pr represents a propyl group, Et represents an ethyl group, and Ph represents a phenyl group.

[Chemical 1]

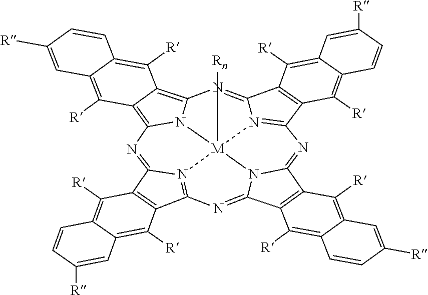

Compound 1 to 15

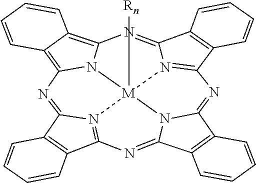

Compound 16 to 20

| Compound | M | R | N | R′ | R″ |
|---|---|---|---|---|---|
| 1 | Si | OSi(n-Bu)₃ | 2 | H | H |
| 2 | Si | OSi(i-Pr)₃ | 2 | H | H |
| 3 | Si | OSi(OEt)₃ | 2 | H | H |
| 4 | Si | OSiPh₃ | 2 | H | H |
| 5 | Si | O(n-C₈H₁₇) | 2 | H | H |
| 7 | Ge | OSi(n-Bu)₃ | 2 | H | H |
| 8 | Sn | OSi(n-Bu)₃ | 2 | H | H |
| 9 | Al | OSi(n-C₆H₁₃)₃ | 1 | H | H |
| 10 | Ga | OSi(n-C₆H₁₃)₃ | 1 | H | H |
| 11 | Cu | — | — | O(n-Bu) | H |
| 12 | Ni | — | — | O(n-Bu) | H |
| 13 | Zn | — | — | H | t-Bu |
| 14 | V═O | — | — | H | t-Bu |
| 15 | H₂ | — | — | H | t-Bu |
| 16 | Si | OSiEt₃ | 2 | — | — |
| 17 | Ge | OSiEt₃ | 2 | — | — |
| 18 | Sn | OSiEt₃ | 2 | — | — |
| 19 | Al | OSiEt₃ | 1 | — | — |
| 20 | Ga | OSiEt₃ | 1 | — | — |

(Constituent Members of Switching Device Other than Active Layer)

The material forming the gate electrode, the source electrode or the drain electrode is not limited particularly if it has required electric conductivity. Examples thereof include: transparent electrically conductive oxides such as ITO (indium-doped tin oxide), IZO (indium-doped zinc oxide), SnO₂, ATO (antimony-doped tin oxide), ZnO, AZO (aluminum-doped zinc oxide), GZO (gallium-doped zinc oxide), TiO₂, FTO (fluorine-doped tin oxide), etc.; transparent electrically conductive polymers such as PEDOT/PSS (poly(3,4-ethylenedioxythiophene)/polystyrenesulfonate); carbon materials such as carbon nanotube; etc. These electrode materials may be formed into films, for example, by a vacuum deposition method, sputtering, a solution application method, etc.

The material used for the insulating layer is not limited particularly as long as it has required insulating effect. Examples thereof include: inorganic materials such as silicon dioxide, silicon nitride, alumina, etc.; and organic materials such as polyester (PEN (polyethylene naphthalate), PET (polyethylene terephthalate) etc.), polycarbonate, polyimide, polyamide, polyacrylate, epoxy resin, polyparaxylylene resin, novolak resin, PVA (polyvinyl alcohol), PS (polystyrene), etc. These insulating film materials may be formed into films, for example, by a vacuum deposition method, sputtering, a solution application method, etc.

As for any other configuration about the aforementioned organic TFT, for example, refer to the description in JP-A-2009-212389.

In addition, for example, amorphous oxide disclosed in JP-A-2010-186860 may be used for the active layer of the switching devices 28. Here, description will be made on an amorphous oxide containing active layer belonging to an FET transistor disclosed in JP-A-2010-186860. The active layer serves as a channel layer of the FET transistor where electrons or holes can move.

The active layer is configured to contain an amorphous oxide semiconductor. The amorphous oxide semiconductor can be formed into a film at a low temperature. Thus, the amorphous oxide semiconductor can be formed preferably on a flexible substrate. The amorphous oxide semiconductor used for the active layer is preferably of amorphous oxide containing at least one kind of element selected from a group consisting of In, Sn, Zn and Cd, more preferably of amorphous oxide containing at least one kind of element selected from a group consisting of In, Sn and Zn, further preferably of amorphous oxide containing at least one kind of element selected from a group consisting of In and Zn.

Specific examples of the amorphous oxide used for the active layer include In₂O₃, ZnO, SnO₂, CdO, Indium-Zinc-Oxide (IZO), Indium-Tin-Oxide (ITO), Gallium-Zinc-Oxide (GZO), Indium-Gallium-Oxide (IGO), and Indium-Gallium-Zinc-Oxide (IGZO).

It is preferable that a vapor phase film formation method targeting at a polycrystal sinter of the oxide semiconductor is used as a method for forming the active layer. Of vapor phase film formation methods, a sputtering method or a pulse laser deposition (PLD) method is suitable. Further, the sputtering method is preferred in view from mass productivity. For example, the active layer is formed by an RF magnetron sputtering deposition method with a controlled degree of vacuum and a controlled flow rate of oxygen.

By a known X-ray diffraction method, it can be confirmed that the active layer formed into a film is an amorphous film. The composition ratio of the active layer is obtained by an RBS (Rutherford Backscattering Spectrometry) method.

In addition, the electric conductivity of the active layer is preferably lower than 10² Scm⁻¹ and not lower than 10⁻⁴ Scm⁻¹, more preferably lower than 10² Scm⁻¹ and not lower than 10⁻¹ Scm⁻¹. Examples of the method for adjusting the electric conductivity of the active layer include an adjusting method using oxygen deficiency, an adjusting method using a composition ratio, an adjusting method using impurities, and an adjusting method using an oxide semiconductor material, as known.

As for any other configuration about the aforementioned amorphous oxide, for example, refer to description in JP-A-2010-186860.

[Insulating Substrate]

Examples of the material of the insulating substrate 16 include glass, a plastic film superior in optical transparency, etc. Examples of the plastic film include films made from polyethylene terephthalate (PET), polyethylene naphthalate (PEN), polyether sulfone (PES), polyether imide, polyetheretherketone, polyphenylene sulfide, polycarbonate (PC), cellulose triacetate (TAC), cellulose acetate propionate (CAP), polyimide, polyalylate, biaxial oriented polystyrene (OPS), etc. In addition, organic or inorganic filler may be contained in these plastic films. A flexible board formed out of aramid, bionanofiber, or the like, having properties, such as flexibility with low thermal expansion and high strength, that cannot be obtained by existing glass or plastic, may be used preferably. Of these, polyalylate (glass transition temperature: about 193° C.) with heat resistance, biaxial oriented polystyrene (decomposition temperature: 250° C.), polyimide (glass transition temperature: about 300° C.), aramid (glass transition temperature: about 315° C.), etc. can be used preferably. In this manner, a scintillator can be formed directly on an insulating substrate in the same manner as the scintillator 118 in the radiological image detection apparatus 101.

(Aramid)

An aramid material has high heat resistance showing a glass transition temperature of 315° C., high rigidity showing a Young's modulus of 10 GPa, and high dimensional stability showing a thermal expansion coefficient of −3 to 5 ppm/° C. Therefore, when a film made from aramid is used, it is possible to easily form a high-quality film for a semiconductor layer, as compared with the case where a general resin film is used. In addition, due to the high heat resistance of the aramid material, an electrode material can be cured at a high temperature to have low resistance. Further, it is also possible to deal with automatic mounting with ICs, including a solder reflow step. Furthermore, since the aramid material has a thermal expansion coefficient close to that of ITO (indium tin oxide), a gas barrier film or a glass substrate, warp after manufacturing is small. In addition, cracking hardly occurs. Here, it is preferable to use a halogen-free (in conformity with the requirements of JPCA-ES01-2003) aramid material containing no halogens, in view of reduction of environmental load.

The aramid film may be laminated with a glass substrate or a PET substrate, or may be pasted onto a housing of a device.

High intermolecular cohesion (hydrogen bonding force) of aramid leads to low solubility to a solvent. When the problem of the low solubility is solved by molecular design, an aramid material easily formed into a colorless and transparent thin film can be used preferably. Due to molecular design for controlling the order of monomer units and the substituent species and position on an aromatic ring, easy formation with good solubility can be obtained with the molecular structure kept in a bar-like shape with high linearity leading to high rigidity or dimensional stability of the aramid material. Due to the molecular design, halogen-free can be also achieved.

In addition, an aramid material having an optimized characteristic in an in-plane direction of a film can be used preferably. Tensional conditions are controlled in each step of solution casting, vertical drawing and horizontal drawing in accordance with the strength of the aramid film which varies constantly during casting. Due to the control of the tensional conditions, the in-plane characteristic of the aramid film which has a bar-like molecular structure with high linearity leading to easy occurrence of anisotropic physicality can be balanced.

Specifically, in the solution casting step, the drying rate of the solvent is controlled to make the in-plane thickness-direction physicality isotropic and optimize the strength of the film including the solvent and the peel strength from a casting drum. In the vertical drawing step, the drawing conditions are controlled precisely in accordance with the film strength varying constantly during drawing and the residual amount of the solvent. In the horizontal drawing, the horizontal drawing conditions are controlled in accordance with a change in film strength varying due to heating and controlled to relax the residual stress of the film. By use of such an aramid material, the problem that the aramid film after casting may be curled.

In each of the contrivance for the easiness of casting and the contrivance for the balance of the film in-plane characteristic, the bar-like molecular structure with high linearity peculiar to aramid can be kept to keep the thermal expansion coefficient low. When the drawing conditions during film formation are changed, the thermal expansion coefficient can be reduced further.

(Bionanofiber)

Components sufficiently small with respect to the wavelength of light do not generate scattering of the light. Accordingly, nanofibers can be used as reinforcement for a transparent and flexible resin material. Of the nanofibers, a composite material (occasionally referred to as bionanofiber) of bacterial cellulose and transparent resin can be used preferably. The bacterial cellulose is produced by bacteria (Acetobacter Xylinum). The bacterial cellulose has a cellulose microfibril bundle width of 50 nm, which is about 1/10 as large as the wavelength of visible light. In addition, the bacterial cellulose is characterized by high strength, high elasticity and low thermal expansion.

When a bacterial cellulose sheet is impregnated with transparent resin such as acrylic resin or epoxy resin and hardened, transparent bionanofiber showing a light transmittance of about 90% in a wavelength of 500 nm while containing a high fiber ratio of about 60 to 70% can be obtained. By the bionanofiber obtained thus, a thermal expansion coefficient (about 3 to 7 ppm) as low as that of silicon crystal, strength (about 460 MPa) as high as that of steel, and high elasticity (about 30 GPa) can be obtained.

As for the configuration about the aforementioned bionanofiber, for example, refer to description in JP-A-2008-34556.

As described above, radiological image detection apparatuses in the following paragraphs are disclosed herein.

(1) A radiological image detection apparatus includes: a phosphor which contains a fluorescent material emitting fluorescence when exposed to radiation; and a sensor panel which detects the fluorescence. The sensor panel has a substrate and a group of photoelectric conversion elements provided on one side of the substrate; the phosphor adheres closely to an opposite surface of the substrate to the side where the group of photoelectric conversion elements are provided; and an irregular structure is formed in the surface of the substrate to which the phosphor adheres closely.

(2) In the radiological image detection apparatus, the irregular structure may form a refractive index distribution in which an average refractive index in a plane perpendicular to a superposition direction of the phosphor on the substrate varies smoothly in the superposition direction.

(3) In the radiological image detection apparatus, an array pitch of concave portions and convex portions in the irregular structure may be smaller than a central wavelength of the fluorescence emitted by the phosphor.

(4) In the radiological image detection apparatus, a bottom surface of each concave portion in the irregular structure may be formed into a lens-surface shape.

(5) In the radiological image detection apparatus, an array pitch of concave portions and convex portions in the irregular structure may be smaller than a size of each of the photoelectric conversion elements.

(6) In the radiological image detection apparatus, the phosphor may include a columnar portion including a group of columnar crystals which are obtained by growing crystals of the fluorescent material into columnar shapes.

(7) In the radiological image detection apparatus, the phosphor may be pasted to the substrate through an adhesive layer which is interposed between the columnar portion and the substrate.

(8) In the radiological image detection apparatus, each of concave portions in the irregular structure may be filled with a material forming the adhesive layer.

(9) In the radiological image detection apparatus, the material forming the adhesive layer may have substantially the same refractive index as the crystals of the fluorescent material.

(10) In the radiological image detection apparatus, the phosphor may be formed by growing the group of columnar crystals directly on the substrate.

(11) In the radiological image detection apparatus, the sensor panel further may have a group of switching devices for reading out electric charges generated by the group of photoelectric conversion elements, element by element; and the group of photoelectric conversion elements and the group of switching devices may be formed in different layers on the substrate, and the group of photoelectric conversion elements and the group of switching devices may be stacked in ascending order of a distance from the substrate.

(12) In the radiological image detection apparatus, radiation may be incident from the sensor panel side.

(13) In the radiological image detection apparatus, the fluorescent material may be CsI:Tl.

(14) In the radiological image detection apparatus, the phosphor may further include a non-columnar portion including a group of non-columnar crystals of the fluorescent material.

(15) In the radiological image detection apparatus, the phosphor may include the non-columnar portion is disposed on a side opposite to a side on which the phosphor adheres closely to the surface of the substrate.

(16) In the radiological image detection apparatus, the irregular structure may be provided all over the surface of the substrate.

(17) In the radiological image detection apparatus, each convex portion in the irregular structure may be formed substantially into a cone shape so as to form a substantially reflection-free surface structure.

(18) In the radiological image detection apparatus, the bottom surface of each concave portion in the irregular structure may be a concave surface directed toward the phosphor.

(19) In the radiological image detection apparatus, an array pitch of concave portions and convex portions in the irregular structure may be smaller than 550 nm.

(20) In the radiological image detection apparatus, each columnar crystal may grow on each concave portion in the irregular structure of the substrate as a starting point.

What is claimed is:

1. A radiological image detection apparatus comprising:
a phosphor which contains a fluorescent material emitting fluorescence when exposed to radiation; and
a sensor panel which detects the fluorescence; wherein:
the sensor panel has a substrate and a group of photoelectric conversion elements provided on one side of the substrate;
the phosphor adheres closely to an opposite surface of the substrate to the side where the group of photoelectric conversion elements are provided; and
an irregular structure is formed in the surface of the substrate to which the phosphor adheres closely.

2. The radiological image detection apparatus according to claim 1, wherein:
the irregular structure forms a refractive index distribution in which an average refractive index in a plane perpendicular to a superposition direction of the phosphor on the substrate varies smoothly in the superposition direction.

3. The radiological image detection apparatus according to claim 2, wherein:
an array pitch of concave portions and convex portions in the irregular structure is smaller than a central wavelength of the fluorescence emitted by the phosphor.

4. The radiological image detection apparatus according to claim 1, wherein:
a bottom surface of each concave portion in the irregular structure is formed into a lens-surface shape.

5. The radiological image detection apparatus according to claim 1, wherein:
an array pitch of concave portions and convex portions in the irregular structure is smaller than a size of each of the photoelectric conversion elements.

6. The radiological image detection apparatus according to claim 1, wherein:
the phosphor includes a columnar portion including a group of columnar crystals which are obtained by growing crystals of the fluorescent material into columnar shapes.

7. The radiological image detection apparatus according to claim 6, wherein:
the phosphor is pasted to the substrate through an adhesive layer which is interposed between the columnar portion and the substrate.

8. The radiological image detection apparatus according to claim 7, wherein:
each of concave portions in the irregular structure is filled with a material forming the adhesive layer.

9. The radiological image detection apparatus according to claim 8, wherein:
the material forming the adhesive layer has substantially the same refractive index as the crystals of the fluorescent material.

10. The radiological image detection apparatus according to claim 6, wherein:
the phosphor is formed by growing the group of columnar crystals directly on the substrate.

11. The radiological image detection apparatus according to claim 1, wherein:
the sensor panel further has a group of switching devices for reading out electric charges generated by the group of photoelectric conversion elements, element by element; and
the group of photoelectric conversion elements and the group of switching devices are formed in different layers on the substrate, and the group of photoelectric conversion elements and the group of switching devices are stacked in ascending order of a distance from the substrate.

12. The radiological image detection apparatus according to claim 1, wherein:
radiation is incident from the sensor panel side.

13. The radiological image detection apparatus according to claim 1, wherein:
the fluorescent material is CsI:Tl.

14. The radiological image detection apparatus according to claim 6, wherein:
the phosphor further includes a non-columnar portion including a group of non-columnar crystals of the fluorescent material.

15. The radiological image detection apparatus according to claim 14, wherein:
the phosphor includes the non-columnar portion is disposed on a side opposite to a side on which the phosphor adheres closely to the surface of the substrate.

16. The radiological image detection apparatus according to claim 1, wherein:
the irregular structure is provided all over the surface of the substrate.

17. The radiological image detection apparatus according to claim 1, wherein:
each convex portion in the irregular structure is formed substantially into a cone shape so as to form a substantially reflection-free surface structure.

18. The radiological image detection apparatus according to claim 4, wherein:
the bottom surface of each concave portion in the irregular structure is a concave surface directed toward the phosphor.

19. The radiological image detection apparatus according to claim 1, wherein:
an array pitch of concave portions and convex portions in the irregular structure is smaller than 550 nm.

20. The radiological image detection apparatus according to claim 10, wherein:
each columnar crystal grows on each concave portion in the irregular structure of the substrate as a starting point.
